(19) United States
(12) Patent Application Publication
(10) Pub. No.: US 2003/0174828 A1
(43) Pub. Date: Sep. 18, 2003

(54) Method for securing control requests for communication links

(76) Inventors: Jorg-Axel Fischer, Hohenkirchen-Siegertsbrunn (DE); Michael Gundlach, Munchen (DE)

Correspondence Address: LERNER AND GREENBERG, P.A., Post Office Box 2480, Hollywood, FL, 33022-2480, US

(21) Appl. No.: 10/377,814

(22) Filed: Feb. 28, 2003

(30) Foreign Application Priority Data
Feb. 28, 2002 (DE) 102 08 746.6

(51) Int. Cl. H04M 7/00

(52) U.S. Cl. 379/229

(57) ABSTRACT

The method allows securing control requests, particularly in intelligent networks. In the event of an incomplete transmission of data for a controlled terminal between a service distribution node and a service control node, a completion procedure is executed particularly for call numbers/network addresses which have been input into the controlled terminal.

### BACKGROUND OF THE INVENTION

### Field of the Invention

The invention relates to a method for securing control requests in communication networks.

Methods for controlling terminals in communication networks used on the basis of the current prior art involve a service distribution node located in an exchange transmitting event data for the controlled terminal to a service control node. These data are then transmitted to a control terminal where they are logged and evaluated. Such a monitoring method is used, in particular, in intelligent networks.

The underlying architecture of service distribution nodes and service control nodes in that control method greatly limits the effectiveness and scope of monitoring options for a terminal which is to be controlled, however.

Thus, in particular, call number inputs or other such inputs of network addresses which are made on the controlled terminal are transmitted incompletely from the service distribution node to the service control node by such an architecture.

There are essentially two reasons for this. First, power resources in the network architecture need to be exhausted in an optimal, rational way for performance reasons. Secondly, a few services which are to be performed or managed by the service control node do not require full call number transmission between the service distribution node and the service control node, and this therefore does not take place.

In intelligent networks, this is the case, by way of example, for a service for managing and securing indirect exchange access (indirect access service, IAS) or in the case of virtual private networks (VPN). These network services involve call numbers which are input on the terminals being transmitted from the service distribution node to the service control node only with a limited number of digits, which means that the service control node cannot clearly establish which terminals have been used to initiate communication processes.

### SUMMARY OF THE INVENTION

It is accordingly an object of the invention to provide a novel method for acquiring control requests in communications links which overcomes the above-mentioned disadvantages of the heretofore-known devices and methods of this general type; specifically, the object is to specify a method for securing control requests from a terminal which is to be controlled in a communication network, particularly in an intelligent network, which ensures full satisfaction of the existing requirements. The method is intended to be easily implementable in an already existing network architecture without significantly affecting the performance of the existing architecture.

With the foregoing and other objects in view there is provided, in accordance with the invention, a method for securing control requests for a communication link in a communication network having a service distribution node, a service control node, and a controlled terminal. The method comprises: in response to an incomplete transmission of event data by the service distribution node to the service control node for a communication link set up by the controlled terminal, executing a completion procedure that is sensitive to network connection data for the controlled terminal between the service distribution node and the service control node.

In other words, incomplete transmission of connection data input on the controlled terminal from the service distribution node to the service control node prompts execution of completion operations between the service control node and the service distribution node.

The service distribution node detects connection data inputs made on the controlled terminal and transmits them to the service control node. The controlled terminal has been identified within the service control node as a terminal which is to be monitored. This selectively limits the monitoring process to the terminal in question. If the service control node registers access to the monitored and marked terminal and if the access data have been transmitted incompletely, the service control node reports back to the service distribution node. Within the service distribution node, the access data are completed and are transmitted to the service control node as a full data record. Within the service control node, the result available for the completion operation is full connection data which have been input on the controlled terminal and which are forwarded to a control terminal.

The interaction between service control node and service distribution node is devised within an already existing network architecture such that it is possible to control a terminal within the network structure comprehensively and completely without changing the architecture.

This method is particularly suitable for intelligent networks. In a standard configuration for an architecture for this network type, for example a GSM mobile radio network, the service control node is in the form of an SCP (Service Control Point) and the service distribution node is in the form of an SSP (Service Switching Point).

The controlled connection data comprise, in particular, call numbers or other such network addresses which are input on the controlled terminal. These form an item of key information which is of central significance for controlling communication processes on terminals.

In a first embodiment of the inventive method, all the network connection data for all the terminals in the communication network have already been stored within the service control node beforehand in a database associated therewith. The terminal to be controlled is marked in the service control node's database by adding a set of monitoring parameters controlling the control process to the controlled terminal's network connection data item and assigning a value to said set of monitoring parameters. As a result of its network connection data having been indicated in connection with the monitoring parameters which have been set, the terminal has been identified as a controlled terminal.

If the service control node has been preconfigured within the existing network architecture such that no network connection data for terminals in the communication network are stored, the network connection data for the controlled terminal are temporarily stored. This is done using a storage operation in a database structure already existing within the service control node or by setting up a temporary control database. The temporary control database is created exclusively for performing the control tasks and is erased when they have been completed.

The temporary marking and/or storage of the network connection data can comprise information about the scope of the control tasks. It is thus possible, in particular, to ascertain the scope of the network services activated on the controlled terminal selectively or to associate activation of particular network services unambiguously with the controlled terminal or to establish that they have been activated.

If the service control node is part of a superordinate administered architecture for service control or if a single service control node is administered by a service management node, the network connection data for the controlled terminal are marked by administration procedures executed at the service management node.

This is particularly expedient when there are a plurality of controlled terminals in the network and hence, as expected, direct administration of network connection data which are to be marked at the service control node results in considerable losses of performance at the service control node. With this refinement, the control sequences are executed separately from their administration, with the service control node remaining fully operational, without losses of power, irrespective of administration procedures which are being executed.

In addition, the administration of monitoring and control tasks can be centralized in the network.

The two marking and/or storage procedures are executed irrespective of the specific refinement of the service control in the network and without any functional co-operation from the terminal which is to be controlled, and thus cannot be established from the corresponding terminal.

If a communication process is started on the controlled terminal, this is registered at the service distribution node, with the controlled terminal transmitting the monitoring-related data for all the communication processes taking place there, particularly all the call numbers input there or other network addressing means, to the service distribution node.

The service control node manages all the activated network services within the communication network, with the service distribution node providing the information which is necessary for this. If the controlled terminal has been marked within the service control node in the manner described above and if incomplete transmission of call numbers input on the terminal or other network addressing means is effected by the service distribution node, the service control node generates a request signal to the service distribution node.

In response to this request signal, the service distribution node transmits the full connection data for the controlled terminal, particularly the full call numbers or network addresses activated on the terminal, to the service control node. These can be output on a control terminal.

In intelligent networks, information is exchanged between service distribution node and service control node preferably in standardized form on the basis of an intelligent network application protocol (INAP). In this case, the aforementioned request signaling is effected using a “COME AGAIN” signal standardized in this protocol.

If there are a plurality of controlled terminals in the communication network or if the control tasks or other utilization of the service control node are very extensive, an individual service control node can be operated as part of a service control center comprising a plurality of service control nodes operating independently of one another.

The service control center is administered by a service management node. The control operations to be performed can be performed by an individual service control node within the service control center or, depending on the current utilization level of the communication network or of the service control center, can be distributed over the service control nodes arranged within the service control center.

Other features which are considered as characteristic for the invention are set forth in the appended claims.

Although the invention is illustrated and described herein as embodied in a method for securing control requests for communication links, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic overview of an architecture with a controlled terminal, an exchange, with a service distribution node, a service control node, and a control terminal in an intelligent network;

FIG. 2 is a schematic overview of the architecture comprising a service distribution node, a service control node, a controlled terminal, and a control terminal in the case of temporary marking/storage by a temporary monitoring parameter for the network connection data associated with the controlled terminal in an intelligent network; and

FIG. 3 is a schematic overview of an architecture comprising a controlled terminal, a service distribution node, and service control nodes, combined in a service control center, with a service management node in an intelligent network.

### DESCRIPTION OF THE PREFERRED EMBODIMENTS

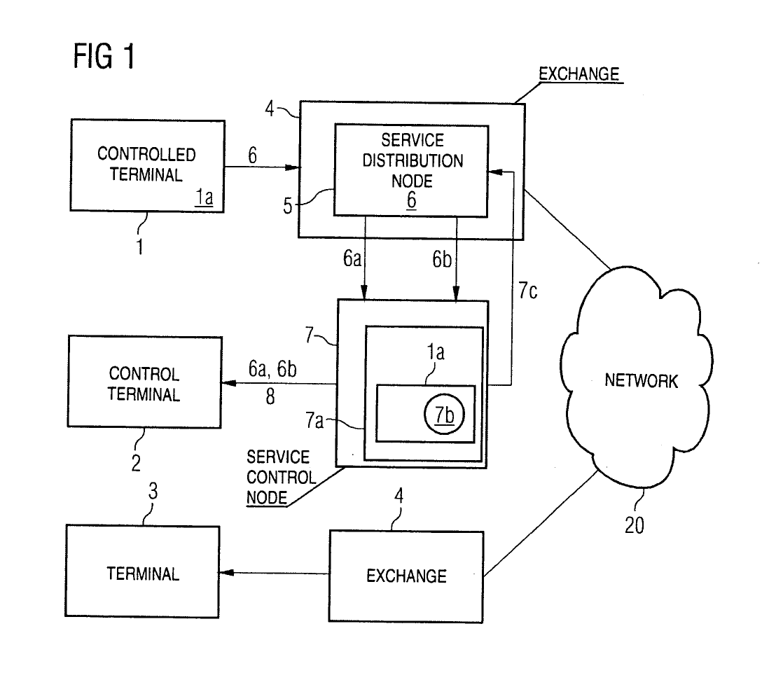

Referring now to the figures of the drawing in detail and first, particularly, to FIG. 1 thereof, there is shown a schematic overview of an architecture comprising a controlled terminal 1, an exchange 4 with a service distribution node 5, a service control node 7, and a control terminal 2 in an intelligent network.

FIG. 1 illustrates a minimal architecture, on which the inventive method is based, with a service distribution node 5 and a service control node 7 in a superordinate network architecture 20 which is in the form of an intelligent network with corresponding network services. In an intelligent network, the service distribution node is in the form of a service switching point SSP, which is known for such communication networks. The service control node is in the form of a service control point SCP, and the service management node is in the form of a service management point SMP.

The network services are allocated to individual terminals within the network by the service distribution node 5, which is preferably located in an exchange 4. The exchange can be in the form of a transit connection point in an intelligent network. The service control node 7 performs operations to control all the network services which are to be processed within the intelligent network.

Output and storage of results and control of executed control tasks for a terminal 1 located within the intelligent network are effected on a control terminal 2 which uses established transmission protocols, preferably X.25 and/or FTAM, to communicate with an SCP.

FIG. 1 shows an embodiment of the inventive method wherein the network connection data 1a for the controlled terminal 1 are permanently stored, besides network connection data for other terminals, in a database 7a associated with the service control node 7. The network connection data item 1a, which is associated with the control terminal 1, is marked within the service control node 7 as needing to be controlled. For this purpose, in an internal database structure, monitoring parameters 7b which have been assigned appropriate values are added to the network connection data item 1a for the controlled terminal as a marking. The monitoring parameters comprise relevant data for the control tasks which are to be performed, such as duration, type and scope of the monitoring, terminal-triggered network services to be monitored separately, and other such information. The network connection data item 1a comprises at least a call number or another means of addressing the controlled terminal 1 in the intelligent network and permits clear identification of the terminal.

When a call number 6 or other kind of network addressing means is input on the controlled terminal 1, a connection is set up via an exchange 4 to a further terminal 3 connected to the network 20.

Transmission of the network addressing means (call number 6) to the service control node 7 by the service distribution node 5 located within the exchange 4 is effected on the basis of the configuration of the service control node and the scope of the services which are to be controlled. Generally, only an incomplete or shortened call number/network address 6a is initially transmitted.

On account of the marking, set within the SCP database using a monitoring parameter 7b, of the network connection data item 1a for the controlled terminal 1, a request signal 7c is generated in response to transmission of an incomplete or shortened call number/network addressing means 6a, as registered by the service control node 7. For communication between the SCP acting as a service control node 7 and the SSP acting as a service distribution node 5, which communication is normal in intelligent networks and is standardized on the basis of an intelligent network application protocol (INAP), the request signal 7c is a “come again” signal.

The service distribution node 5 then transmits a call number part and/or address part 6b completing the shortened call number/network address 6a to the service control node 7. The incomplete call number part 6a and the completing call number part 6b are put together within the service control node 7 to give a full call number/network addressing means 6 and/or are transmitted separately, together with the event data 8, to the control terminal 2.

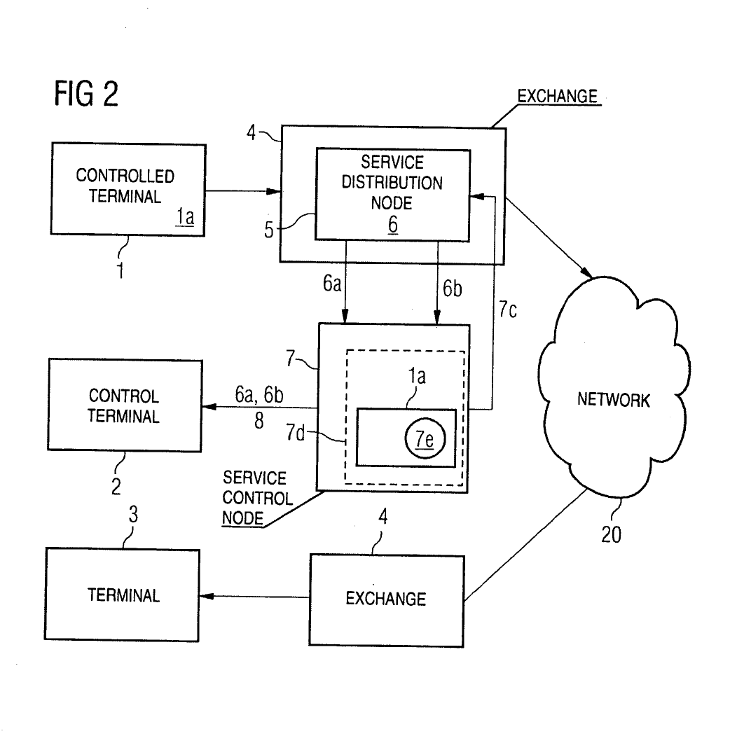

FIG. 2 shows a schematic overview of the architecture comprising service distribution node 5, service control node 7, controlled terminal 1 and control terminal 2 in the case of temporary marking/storage by a temporary monitoring parameter 7e for the network connection data 1a associated with the controlled terminal 1 in an intelligent network, and

FIG. 2 shows an architecture that is comparable to that in the previous exemplary embodiment, between service distribution node 5 and service control node 7. In this exemplary embodiment, the network connection data item for the controlled terminal 1 has not been stored within the service control node beforehand, or the service control node has no internal database from the outset. In this case, it is not possible to establish that communication links are being set up on the controlled terminal 1 or that other inputs are being made.

In this case, the network connection data item 1a for the controlled terminal 1 is stored within the service control node 7 in a temporary control database 7d and is marked using temporary monitoring parameters 7e. The completion operations proceed in the manner already described.

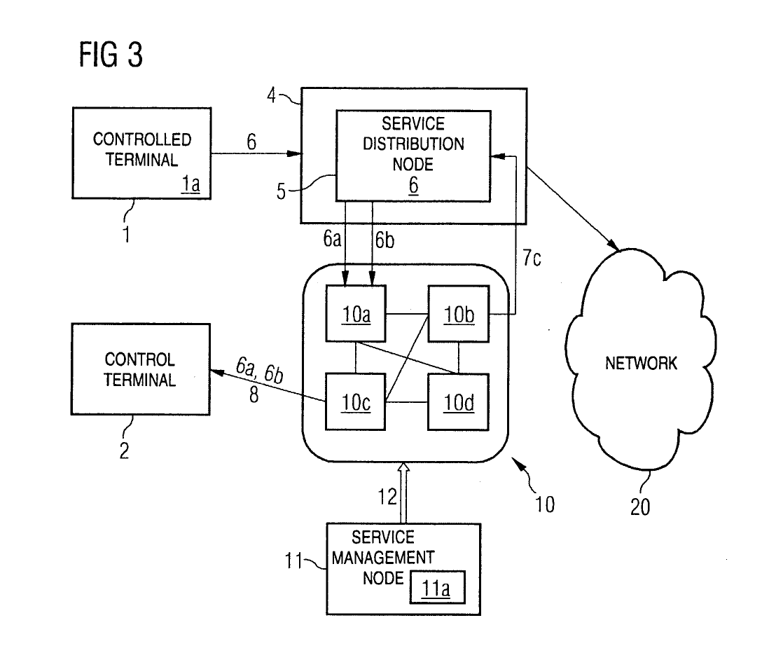

For intelligent networks wherein extensive control tasks, particularly for a plurality of controlled terminals, arise, the performance of an individual service control node 7 can drop considerably as a result of the control tasks being processed. In this case, instead of a single service control node 7, a service control center 10 is provided wherein a series of service control nodes 7 carry out control processes in parallel with one another. This is shown schematically in FIG. 3. FIG. 3 shows a schematic overview of an architecture comprising controlled terminal 1, service distribution node 5 and service control nodes 10a, 10b, 10c and 10d, combined in a service control center 10, with a service management node 11 in an intelligent network. The service control center 10 is configured and administered 12 by a service management node 11. To this end, the service management node 11 is equipped with a service development environment 11a which allows simple management of the service control center 10 as a software-type front end.

In intelligent networks, the service management node is in the known form of a service management point (SMP), while the software-type front end is in the form of a service creation environment (SCE).

If there are a large number of controlled terminals in the network, the aforementioned transmission/completion processes can, as one alternative, be concentrated at a subordinate service control node, with the remaining service control nodes within the service control center performing other network services.

Within the service control center, the sequence of the completion method described above can also be distributed over a plurality of subordinate service control nodes 10a, . . . , 10d. In particular, the subordinate service control nodes can be in the form of reception or transmission interfaces in the service control center. In FIG. 3, a subordinate service control node is set up, by way of example, as a reception node 10a for receiving information which is transmitted to the service control center 10 by the service distribution node 5. A further subordinate service control node is provided as a transmission node 10b for transmitting information from the service control center 10 to the service distribution node 5.

In this exemplary embodiment, call numbers/network addresses are received at the reception node 10a from the service distribution node 5, with the aforementioned request signal being triggered at the transmission node 10b. A monitoring node 10c associated with the communication between the service control center and the control terminal 2 performs the forwarding operations for the call number parts to the control terminal.

We claim:

1. In a communication network having a service distribution node, a service control node, and a controlled terminal, a method for securing control requests for a communication link, which comprises:
in response to an incomplete transmission of event data by the service distribution node to the service control node for a communication link set up by the controlled terminal, executing a completion procedure that is sensitive to network connection data for the controlled terminal between the service distribution node and the service control node.

2. The method according to claim 1, wherein the event data comprise a call number activated by the controlled terminal as parts to be completed in the completion procedure.

3. The method according to claim 1, wherein the event data comprise a network address activated by the controlled terminal as parts to be completed in the completion procedure.

4. The method according to claim 1, which further comprises, if a permanent database containing network connection data for terminals is present and associated with the service control node, prompting a monitoring parameter to be assigned to the network connection data for the controlled terminal as a marker for a control process to be carried out.

5. The method according to claim 4, which comprises setting up or managing the monitoring parameter at a service management node associated with and administering the service control node.

6. The method according to claim 1, which further comprises, in case a permanent database associated with the service control node is absent, prompting temporary marking of the controlled terminal by creating a temporary control database and assigning temporary monitoring parameters during an execution of the control tasks.

7. The method according to claim 4, which comprises setting up and managing the temporary monitoring parameter at a service management node associated with and administering the service control node.

8. The method according to claim 1, which comprises, upon receiving an incomplete part of a network address transmitted by the service distribution node at the service control node, generating a request signal and transmitting the request signal to the service distribution node and, at the service distribution node, triggering a transmission of an additional part of the network address for completing the incomplete part of the call number or network address.

9. The method according to claim 8, which comprises forming the request signal in an intelligent network by a “come again” signal standardized for the intelligent network within the INAP protocol.

10. The method according to claim 1, which comprises marking by a monitoring parameter in connection with a “come again” signal standardized on the basis of INAP for modifying an indirect access service in an intelligent network.

11. The method according to claim 6, which comprises utilizing a temporary marking with the temporary monitoring parameter in connection with a “come again” signal standardized on the basis of INAP modify a virtual private network service in an intelligent network.

12. The method according to claim 1, wherein the service control node is integrated within a service control center comprising subordinate service control nodes operating independently of one another and the service control center is administered centrally by the service management node, with a service logic unit formed to concentrate the control and/or completion procedures on one of the subordinate service control nodes in the service control center.

13. The method according to claim 1, wherein the service control node is integrated within a service control center comprising subordinate service control nodes operating independently of one another and the service control center is administered centrally by the service management node, with a service logic unit formed to assign the control and/or completion procedures in a distribution over the individual subordinate service control nodes.

14. A method for securing control requests for communication links, which comprises:
in response to an incomplete transmission of event data by a service distribution node to a service control node for a communication link set up by a controlled terminal in a communication network, executing a completion procedure that is sensitive to network connection data for the controlled terminal between the service distribution node and the service control node.
